(19) United States
(12) Patent Application Publication
(10) Pub. No.: US 2007/0276837 A1
(43) Pub. Date: Nov. 29, 2007

(54) CONTENT SUBSCRIPTION

(76) Inventors: William K. Bodin, Austin, TX (US); David Jaramillo, Lake Worth, FL (US); Jesse W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/420,016

(22) Filed: May 24, 2006

(51) Int. Cl. G06F 17/30

(52) U.S. Cl. 707/10

(57) ABSTRACT

Methods, systems, and computer program products are provided for content subscription. Embodiments include receiving from a user device configuration information; receiving from a user one or more identifications of content providers for delivery to a device; and instructing the one or more content providers to deliver content to the device associated with the device configuration information.

### BACKGROUND OF THE INVENTION

1. Field of the Invention

The field of the invention is data processing, or, more specifically, methods, systems, and products for content subscription.

2. Description of Related Art

Subscribing to content provided by content providers such as RSS content or podcasts, for example, currently requires a user to download to a client device an aggregator provided by the specific content provider. Current content subscription also requires the user to subscribe to the content with the target device such that the aggregator may be downloaded to the device during subscription. Furthermore, current content subscription also typically requires subscription to each content provider individually. There is therefore an ongoing need for improvement in content subscription.

### SUMMARY OF THE INVENTION

Methods, systems, and computer program products are provided for content subscription. Embodiments include receiving from a user device configuration information; receiving from a user one or more identifications of content providers for delivery to a device; and instructing the one or more content providers to deliver content to the device associated with the device configuration information.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for content subscription according to embodiments of the present invention.

FIG. 2 sets forth a block diagram of automated computing machinery comprising an exemplary content subscription service server useful in content subscription according to embodiments of the present invention.

FIG. 3 sets forth a flow chart illustrating an exemplary method for content subscription according to embodiments of the present invention.

FIG. 4 sets forth a block diagram of an exemplary web page useful in content subscription according to the present invention.

FIG. 5 sets forth a block diagram of a content presentation customization page useful in content subscription according to the present invention.

FIG. 6 sets forth a flow chart illustrating an exemplary method for token-based content subscription according to the present invention.

FIG. 7 sets forth a flow chart illustrating an exemplary method for delivering content to a device associated with the subscription token further comprises that includes presenting the subscription token to the issuer.

FIG. 8 sets forth another exemplary method for delivering content to a device associated with the subscription token that includes extracting from the token content delivery information.

### DETAILED DESCRIPTION OF EXEMPLARY EMBODIMENTS

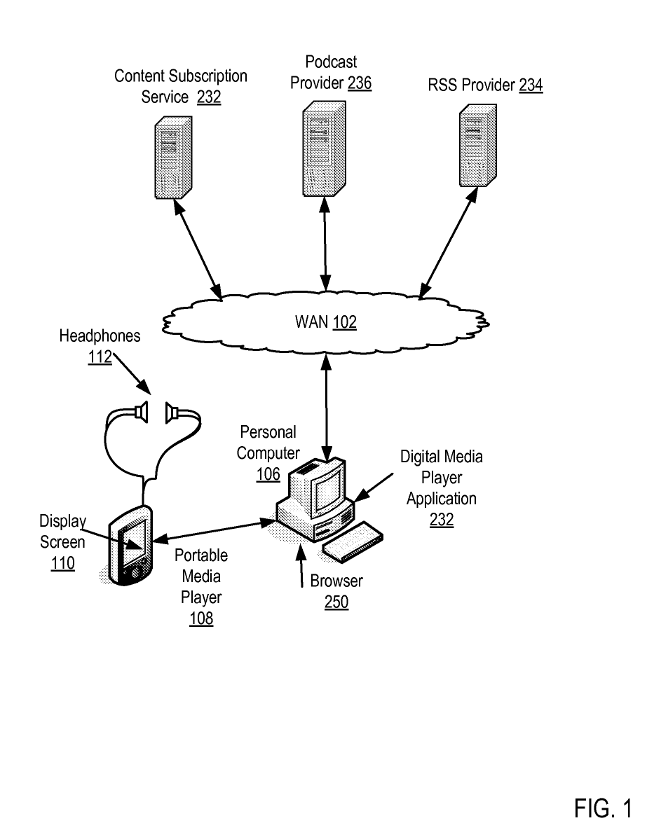

Exemplary methods, systems, and products for content subscription according to embodiments of the present invention are described with reference to the accompanying drawings, beginning with FIG. 1. FIG. 1 sets forth a network diagram illustrating an exemplary system for content subscription and token-based content subscription according to embodiments of the present invention.

The system of FIG. 1 operates generally for content subscription according to embodiments of the present invention by receiving from a user device configuration information; receiving from a user one or more identifications of content providers for delivery to a device; and instructing the one or more content providers to deliver content to the device associated with the device configuration information. The system of FIG. 1 also operates generally for token-based content subscription according to embodiments of the present invention by receiving a request for content subscription; receiving from a user a subscription token; and delivering content to a device associated with the subscription token.

The exemplary system of FIG. 1 includes a content subscription service (232). The exemplary content subscription service of FIG. 1 is an enterprise service capable of receiving from a user device configuration information; receiving from a user one or more identifications of content providers for delivery to a device; and instructing the one or more content providers to deliver content to the device associated with the device configuration information. The exemplary content subscription service of FIG. 1 is also capable of establishing a user account and issuing to a user a subscription token associated with the user account. A subscription token is mechanism for providing to a content provider information useful in subscribing to the content and that has already been provided by the user to the content subscription service issuing the token. Such a subscription token may be a token presented to a content provider by a user who in turn presents the token to the issuing content subscription service to retrieve content delivery information to deliver content. Alternatively, content delivery information may be embedded into the subscription token itself by a content subscription service such that content providers may extract the delivery information from the token.

The exemplary system of FIG. 1 includes two content providers: a podcast provider (236) and an RSS provider (234). Podcasting is the method of distributing multimedia files, such as audio programs or music videos, over the Internet for playback on mobile devices and personal computers. The term podcast, like “radio”, can mean both the content and the method of delivery. The host or author of a podcast is often referred to as a “podcaster”. A podcast provider may provide direct download of the podcast or streaming of the podcast.

RSS (‘Really Simple Syndication’) is a broad term describing a family of XML file formats for web syndication used by news websites, weblogs, and other content providers. The abbreviation is often used to refer to the following exemplary standards: Rich Site Summary (RSS 0.91), RDF Site Summary (RSS 0.9, 1.0 and 1.1), and Really Simple Syndication (RSS 2.0).

The exemplary content providers (234 and 236) and of FIG. 1 are capable of token-based content subscription according to embodiments of the present invention by receiving a request for content subscription; receiving from a user a subscription token; and delivering content to a device associated with the subscription token. The content providers (234 and 236) are capable of delivering content to a device associated with the subscription token by presenting the subscription token to the issuer; receiving in response to presenting the subscription token the content delivery information; and delivering content to a device in accordance with the content delivery information. The content providers (234 and 236) are capable of delivering content to a device associated with the subscription token by extracting from the token content delivery information; and delivering content to a device in accordance with the content delivery information.

The system of FIG. 1 includes a personal computer (106) having installed upon it a browser (250) empowering a user to view web pages such as those provided by a content subscription service and provided by subscription by the RSS provider (234). The personal computer (106) of FIG. 1 also has installed upon it a digital media player application (232) capable of receiving and managing podcasts provided by subscription from the podcast provider (236). A digital media player application is an application that manages media content such as audio files and video files. Such digital media player applications are typically capable of transferring media files to a portable media player. Examples of digital media player applications include Music Match™, iTunes®, Songbird™, and others as will occur to those of skill in the art.

The system of FIG. 1 also includes a portable media player (108). The portable media player of FIG. 1 is capable of playing media files such as for example, MPEG files, AAC compressed .mp4 files, and others provided by subscription by the podcast provider (236). The portable media player (108) of FIG. 1 also includes a display screen (110) capable of displaying information stored as metadata associated with media files of the file types supported by the portable media player. The portable media player also includes headphones (112) for audio rendering of media files supported by the portable media player.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

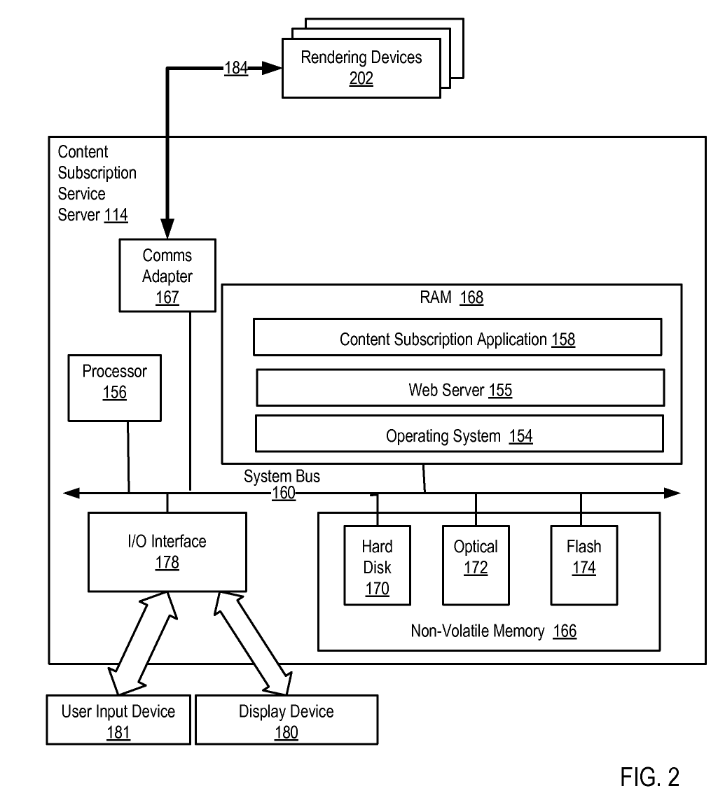

Content subscription in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary content subscription service server (152) useful in content subscription according to embodiments of the present invention. The content subscription service server (152) of FIG. 2 includes at least one computer processor (156) or ‘CPU’ as well as random access memory (168) (‘RAM’) which is connected through a system bus (160) to processor (156) and to other components of the content subscription service server.

Stored in RAM (168) is a content subscription application (158) computer program instructions for content subscription capable of receiving from a user device configuration information; receiving from a user one or more identifications of content providers for delivery to a device; and instructing the one or more content providers to deliver content to the device associated with the device configuration information. The content subscription application (158) also includes computer program instructions for token-based content subscription capable of establishing a user account and issuing to a user a subscription token associated with the user account.

Also stored in RAM (168) is a web server (155), computer program instructions capable of serving up web pages to clients. Such web pages may be designed with graphical user interface (‘GUI’) input widgets designed to receive user security information and content delivery information such as device IDs and network addresses associated with devices capable of receiving content from a content provider.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), content subscription application (158) and web server (155) in the example of FIG. 2 are shown in RAM (168), but many components of such software typically are stored in non-volatile memory (166) also.

Content subscription service server (152) of FIG. 2 includes non-volatile computer memory (166) coupled through a system bus (160) to processor (156) and to other components of the content subscription service server (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example content subscription service server of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary content subscription service server (152) of FIG. 2 includes a communications adapter (167) for implementing data communications (184) with other computers (1 82). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for content subscription according to embodiments of the present invention include modems for wired dial-up communications, Ethernet (IEEE 802.3) adapters for wired network communications, and 802.11b adapters for wireless network communications.

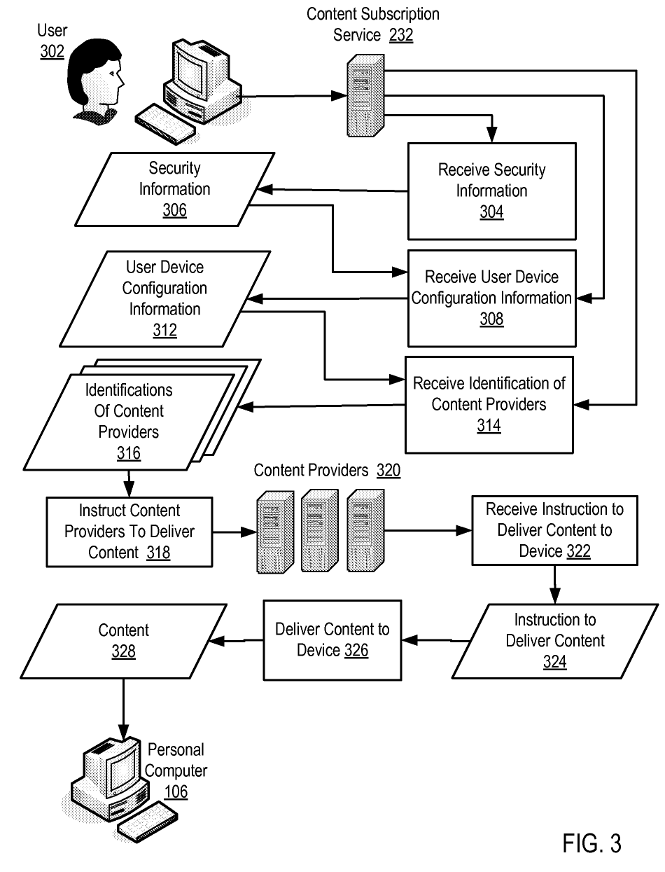

For further explanation, FIG. 3 sets forth a flow chart illustrating an exemplary method for content subscription according to embodiments of the present invention that includes receiving (304) from a user (302) security information (306). Security information is data used by a content subscription service (232) according to the present invention for among other things authentication of a user. Such security information may be used to authenticate a user having established a user account with a content subscription service.

Receiving (304) from a user (302) security information (306) according to the present invention may be carried out by receiving from a user a user ID and receiving from a user password. A user ID and password may be received from a user through for example web page provided by a content subscription service and accessible by a user through a browser. Such a web page may include GUI input widgets designed to receive from a user a user ID and password.

The method of FIG. 3 also includes receiving (308) from a user (302) device configuration information (312). Device configuration information is information necessary to identify a target device to deliver content and information useful in effecting the delivery of that content. Receiving from a user device configuration information according to the method of FIG. 3 may be carried out by receiving from a user a device ID identifying the target device for content delivery and receiving from a user a network address for delivery of the content. A device ID is a unique identification of a particular device identified for receiving content according to a subscription with a particular subscription provider.

The method of FIG. 3 also includes receiving (314) from a user (302) one or more identifications (316) of content providers for delivery to a device (106). A content provider is a provider of subscription content. That is, a provider of content that periodically delivers content to a device in accordance with a subscription with the user. Such content providers may be provider of RSS content, podcast content, video content, or any other content available through subscription with a content provider.

Receiving (314) from a user (302) one or more identifications (316) of content providers for delivery to a device (106) may be carried out by receiving a URL identifying a content provider through a web page provided by a content subscription service and accessible by a user with a browser. Such a web page may also be configured to accept a user's dragging and dropping a URL from the address bar of another open instance of a browser.

The method of FIG. 3 also includes instructing (318) the one or more content providers (320) to deliver content to the device (106) associated with the device configuration information (312). Instructing (318) the one or more content providers (320) to deliver content to the device (106) associated with the device configuration information (312) may be carried out by providing the security information to the content providers and providing the configuration information to the content providers necessary to deliver content to the identified target device.

The method of FIG. 3 also includes receiving (322) by a content provider (320) the instruction (324) to deliver content to the device (106). Receiving (322) by a content provider (320) the instruction (324) to deliver content to the device (106) may include receiving by the one or more content providers security information for a user and device configuration information necessary to deliver content to the target device. Upon receiving an instruction to deliver content to the device, content providers may establish an account for the user for content subscription. Establishing an account for the user for content subscription may include saving security information for the user and device configuration information for the user in association with the user account. Establishing an account for the user may also include billing the user for the subscription of content.

The method of FIG. 3 also includes delivering (326) content (328) to the device (106) in response to the instruction (324). Delivering (326) content (328) to the device (106) in response to the instruction (324) may be carried out by pushing content to the identified device, pushing an aggregator to the identified device and having content pulled to the device by the aggregator, or any other method of delivering content to the device that will occur to those of skill in the art.

Content subscription services according to the present invention may advantageously maintain a user account for user such that the user may be required only once to provide security information and device configuration information for content subscription. Such a user account may therefore include user security information and user device configuration information.

A user account may also include user content presentation parameters. User content presentation parameters are preferences established by a user for presentation to one or more content providers such that subscriptions of content conform to the user presentation parameters. User content presentation parameters may include preferences for number of RSS items to include an RSS feed, the preferred period of content delivery, a preferred ordering of content, and others as will occur to those of skill in the art.

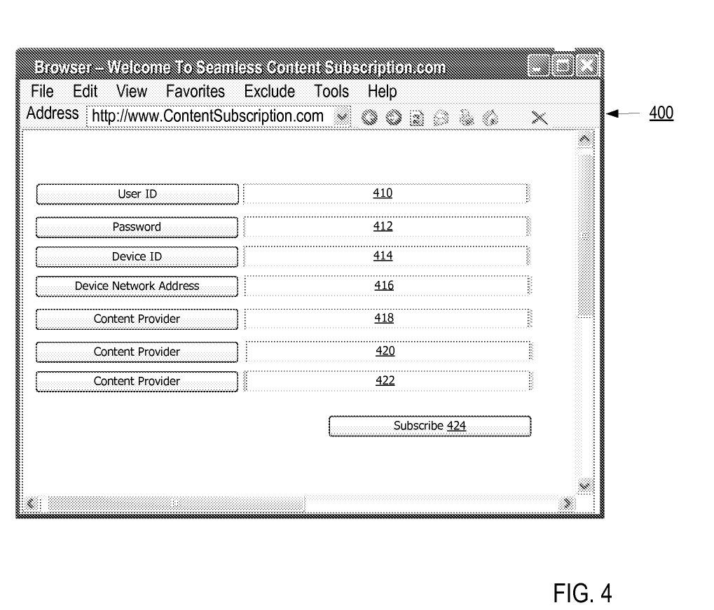

As discussed above, security information and device configuration information may be received through for example a web page provided by a subscription service and accessible by a user through a browser. For further explanation, therefore, FIG. 4 sets forth a block diagram of an exemplary web page (400) useful in content subscription according to the present invention. The exemplary web page of FIG. 4 is capable of receiving security information from a user and device configuration information from a user.

The exemplary web page of FIG. 4 is capable of receiving security information from a user. The exemplary web page (400) includes a GUI input widget (410) capable of receiving from a user a user ID. The exemplary web page (400) of FIG. 4 also includes a GUI input widget (412) capable of receiving from a user password.

The exemplary web page of FIG. 4 is capable of receiving device configuration information from a user. The exemplary web page (400) of FIG. 4 also includes a GUI input widget (414) capable of receiving from a user a device ID identifying the target device for content delivery. The exemplary web page (400) of FIG. 4 also includes a GUI input widget (416) for receiving a device network address identifying a network address to which subscription content may be deliver in accordance with the present invention.

The exemplary web page of FIG. 4 is capable of receiving identifications of one or more content providers. The exemplary web page (400) of FIG. 4 includes GUI input widgets (418, 420, 422) capable of receiving identifications, such as URLs, to content providers. Web pages such as the exemplary web page of FIG. 4 are often capable of receiving a URL dragged and dropped by use of mouse from an address bar of another instance of a web browser currently displaying a page associated with the URL.

The exemplary web page (400) useful in content subscription according to the present invention presented in FIG. 4 is for explanation and not for limitation. In fact, web pages useful in content subscription according to the present invention may designed in any number of ways as will occur to those of skill in the art and all such ways are well within the scope of the present invention.

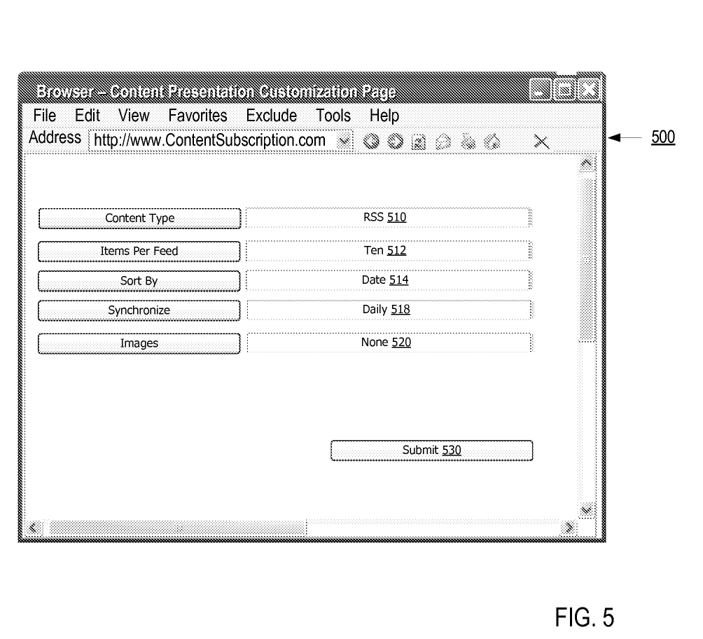

The presentation of the content ultimately delivered by the content provider according to the content subscription of the present invention may also be customized according to content presentation parameters. For further explanation, therefore, FIG. 5 sets forth a block diagram of a content presentation customization page (500) useful in content subscription according to the present invention. The content presentation customization page (500) of FIG. 5 is capable of receiving from a user content presentation parameters.

The exemplary content presentation customization page (500) of FIG. 5 includes a GUI input widget (510) for receiving an identification of a content type for which the user content presentation parameters apply. In the example of FIG. 5, the content type is identified as RSS content.

The content presentation customization page (500) of FIG. 5 includes a GUI input widget (512) for receiving an identification of the number of RSS items to be delivered with a particular RSS feed. In the example of FIG. 5, the number of RSS items so identified is ten.

The content presentation customization page (500) of FIG. 5 includes a GUI input widget (514) for receiving an identification of a preference for the sorting of items in the RSS feed. In the example of FIG. 5, the sorting preference indicates that RSS items are to be sorted by date.

The content presentation customization page (500) of FIG. 5 includes a GUI input widget (518) for receiving an identification of the frequency with which to synchronize or deliver content from the content provider. In the example of FIG. 5, the frequency for synchronization is daily.

The content presentation customization page (500) of FIG. 5 includes a GUI input widget (520) for receiving images preferences identifying whether images are to be delivered with content provided by the content provider. In the example of FIG. 5, the preferences indicate no images are to be provided.

Content subscription service having receiving from the user the content presentation parameters may store the presentation parameters in association with a user account and provide the content presentation parameters to the content subscription service.

The content presentation customization page (500) of FIG. 5 is presented for explanation and not for limitation. In fact, content presentation may be customized according to any number of content presentation parameters in many ways and all such was may be useful in content subscription according to the present invention.

### Token-Based Content Subscription

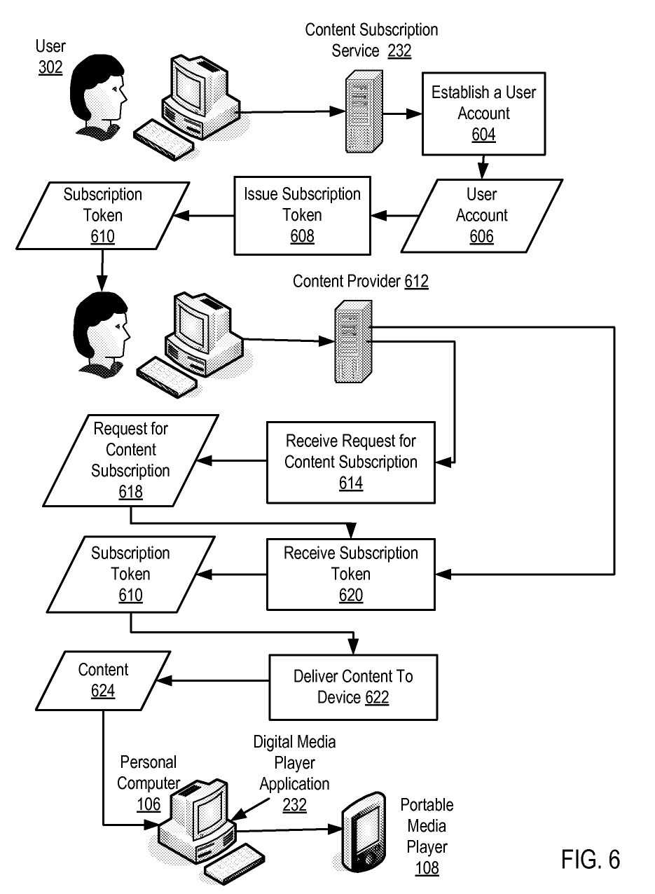

As discussed above, content subscription services may usefully provide a token that may be presented to various content providers by a user for content subscription according to the present invention. For further explanation, therefore, FIG. 6 sets forth a flow chart illustrating an exemplary method for token-based content subscription according to the present invention. The method of FIG. 6 includes establishing (604) a user account (606). Establishing (604) a user account (606) according to the method of FIG. 6 may be carried out by receiving user security information and receiving content delivery information for a user and associating the user security information and content delivery information with an account for the user. As discussed above, user security information may include a user ID and password used to authenticate a user. Content delivery information may include device configuration parameters such as a device ID and network address and user content presentation parameters defining preferences for content delivery as discussed above.

The method of FIG. 6 includes issuing (608) to a user (302) a subscription token (610) associated with the user account (610). A subscription token is mechanism for providing to a content provider information useful in subscribing to the content and that has already been provided by the user to the content subscription service issuing the token. Such a token may be presented to a content provider who in turn presents the token to the issuing content subscription service to retrieve content delivery information to deliver content. Such a subscription token may be implanted as an XML-based subscription token. For further explanation, consider the following XML-based subscription token.

<subscription token ID = 411234>
<security token issuer = Http://someSubscriptionSerice.com>
</subscription token ID >

The exemplary subscription token above has a unique subscription token identification of ‘411234.’ The exemplary subscription token identifies the issuer of the subscription token with a universal resource locator (‘URL’) Http://someSubscriptionSerice.com. The URL may be invoked by a content provider with the subscription token ID to retrieve from the subscription token issued content delivery information useful by a content provider to deliver content to a user.

Alternatively, issuing (608) to a user (302) a subscription token (608) associated with the user account (606) may include embedding within the subscription token content delivery information. That is, delivery information may be embedded into the subscription token itself by a content subscription service such that content providers may extract the delivery information from the token. A subscription token having embedded content delivery information may be implemented as an XML-based token. For further explanation, consider the following exemplary subscription token:

```
<subscription token ID = 11234>
    <security information>
        <user ID = Joe>
        <password = somePassword>
    </security information>
    <content delivery information>
        <device ID= SomeDeviceNo1233333>
        <networkAddress=192.168.1.35192.168.1.35>
    </content delivery information>
</subscription token ID>
```

The exemplary XML-based subscription token above has a unique subscription token ID of ‘11234.’ The exemplary XML-based subscription token above has embedded within it security information for the user defining a user ID of ‘Joe’ for the user and a password for the user of ‘somePassword.’ The exemplary XML-based subscription token above also has embedded within it content delivery information identifying a target device for delivering content as a device having an identification of ‘SomeDeviceNo1233333’ that is capable of receiving content at the IP network address ‘192.168.1.35192.168.1.35’.

The method of FIG. 6 includes receiving (614) a request (618) for content subscription and receiving (620) from a user (302) a subscription token (610). In the example of FIG. 6, a content provider receives a request (618) for content subscription. Such a request for content subscription may be received, for example, through the content providers web site designed to receive from a user a request for content subscription and receive from the user a subscription token.

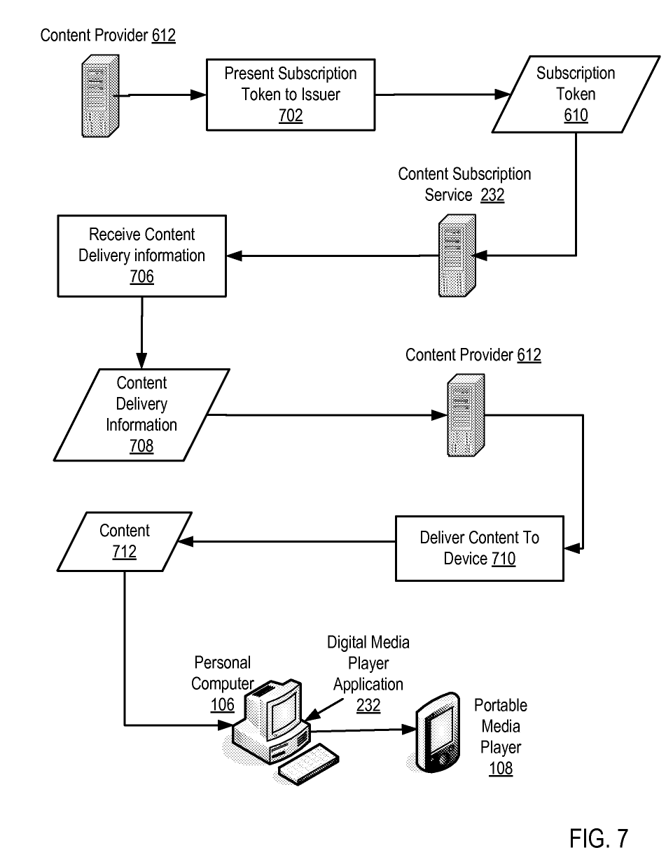

The method of FIG. 6 includes delivering (622) content (624) to a device (106) associated with the subscription token (610). Delivering content to a device associated with the subscription token may be carried out by presenting the subscription token to the issuer, receiving in response to presenting the subscription token the content delivery information; and delivering content to a device in accordance with the content delivery information as discussed below with reference to FIG. 7. Delivering content to a device associated with the subscription token may also be carried out by extracting from the token content delivery information and delivering content to a device in accordance with the content delivery information.

As discussed above, delivering content to a device associated with a subscription token may be carried out by content provider presenting a subscription token received from a user to the issuer of the subscription token. For further explanation, therefore, FIG. 7 sets forth a flow chart illustrating an exemplary method for delivering content to a device associated with the subscription token further comprises that includes presenting (702) the subscription token (610) to the issuer (702). As discussed above, a subscription token may be an XML-based subscription token. Consider again the following XML based subscription token.

<subscription token ID = 411234>
<security token issuer = Http://someSubscriptionService.com>
</subscription token ID >

The exemplary subscription token above has a unique subscription token identification of ‘411234.’ The exemplary subscription token identifies the issuer of the subscription token with a universal resource locator (‘URL’) Http://someSubscriptionService.com. Presenting the exemplary subscription token to the issuer according to the method of FIG. 7 may be carried out by invoking the URL ‘Http://someSubscriptionService.com’ contained in the subscription token and providing the subscription token ID to the subscription service through the URL. The method of FIG. 7 also includes receiving (706) in response to presenting the subscription token (610) the content delivery information (706). In response to presenting the subscription token (610) a content subscription service may retrieve from a user account the content delivery information associated with the subscription token and provide to the content provider the content delivery information (706) associated with the subscription token.

The method of FIG. 7 also includes delivering (710) content (712) to a device (106) in accordance with the content delivery information (708). In the example of FIG. 7, delivering (710) content (712) to a device (106) in accordance with the content delivery information (708) is carried out by a content provider having received the content delivery information from the subscription service issuing the subscription token. Delivering (710) content (712) to a device (106) in accordance with the content delivery information (708) may be carried out by delivering content to a device identified by a device ID received from the content subscription service at a network address received from the content subscription service. Delivering (710) content (712) to a device (106) in accordance with the content delivery information (708) may also include delivering content in accordance with content presentation parameters defined in the content delivery information received from the content subscription service.

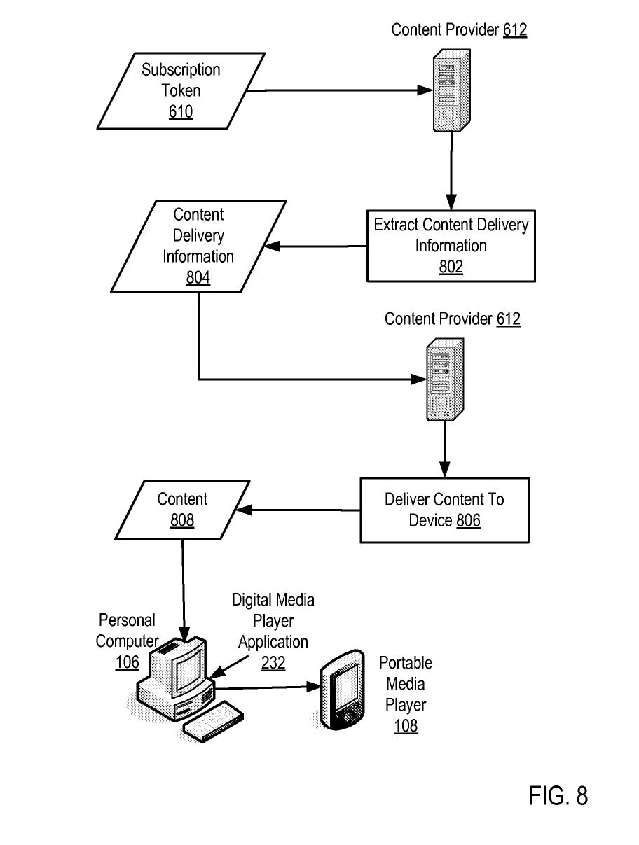

As discussed above, subscription tokens may have content delivery information embedded within the token. For further explanation, therefore, FIG. 8 sets forth another exemplary method for delivering content to a device associated with the subscription token. The method of FIG. 8 includes extracting (802) from the token (610) content delivery information (804). A subscription token may be an XML-based subscription token. For further explanation, consider again the following XML-based subscription token.

```
<subscription token ID = 11234>
    <security information>
        <user ID = Joe>
        <password = somePassword>
    </security information>
    <content delivery information>
        <device ID= SomeDeviceNo1233333>
        <networkAddress=192.168.1.35192.168.1.35>
    </content delivery information>
</subscription token ID >
```

The exemplary XML-based subscription token above has a unique subscription token ID of ‘11234.’ The exemplary XML-based subscription token above has embedded within it security information for the user defining a user ID of ‘Joe’ for the user and a password for the user of ‘somePassword.’ The exemplary XML-based subscription token above also has embedded within it content delivery information identifying a target device for delivering content as a device having an identification of ‘SomeDeviceNo1233333’ that is capable of receiving content at the IP network address ‘192.168.1.35192.168.1.35’. Extracting from the exemplary subscription token content delivery information according to the method of FIG. 8 may be carried out by identifying the <content delivery information>tag in the subscription token and extracting the device ID and network address identified by the <content delivery information>tag.

The method of FIG. 8 also includes delivering (8060 content (808) to a device (106) in accordance with the content delivery information (804). Delivering (806) content (808) to a device (106) in accordance with the content delivery information (804) may be carried out by delivering content to a device identified by a device ID in the subscription token capable of accepting content at a network address identified in the subscription token. Delivering (806) content (808) to a device (106) in accordance with the content delivery information (804) may also include delivering content in accordance with content presentation parameters defined in the content delivery information.

Exemplary embodiments of the present invention are described largely in the context of a fully functional computer system for content subscription. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for content subscription, the method comprising:
receiving from a user device configuration information;
receiving from a user one or more identifications of content providers for delivery to a device; and
instructing the one or more content providers to deliver content to the device associated with the device configuration information.

2. The method of claim 1 further comprising:
receiving by a content provider the instruction to deliver content to the device; and
delivering content to the device in response to the instruction.

3. The method of claim 1 further comprising receiving from a user security information.

4. The method of claim 3 wherein receiving from a user security information further comprises:
receiving from a user a user ID;
receiving from a user password.

5. The method of claim 1 wherein receiving from a user device configuration information further comprises:
receiving from a user a device ID identifying the target device for content delivery;
receiving from a user a network address for delivery of the content.

6. The method of claim 1 further comprises:
receiving from a user content presentation parameters; and
providing the content presentation parameters to the content subscription service.

7. The method of claim 1 further comprises maintaining a user account including user security information, user device configuration information, and user content presentation parameters.

8. A system for content subscription, the system comprising:
a computer processor;
a computer memory operatively coupled to the computer processor, the computer memory having disposed within it computer program instructions capable of:
receiving from a user device configuration information;
receiving from a user one or more identifications of content providers for delivery to a device; and
instructing the one or more content providers to deliver content to the device associated with the device configuration information.

9. The system of claim 8 wherein the computer memory also has disposed within it computer program instructions capable of receiving from a user security information.

10. The system of claim 10 wherein computer program instructions capable of receiving from a user security information further comprise computer program instructions capable of:
receiving from a user a user ID;
receiving from a user password.

11. The system of claim 8 wherein computer program instructions capable of receiving from a user device configuration information further comprise computer program instructions capable of:
receiving from a user a device ID identifying the target device for content delivery;
receiving from a user a network address for delivery of the content.

12. The system of claim 8 wherein the computer memory also has disposed within it computer program instructions capable of:
receiving from a user content presentation parameters; and
providing the content presentation parameters to the content subscription service.

13. The system of claim 8 wherein the computer memory also has disposed within it computer program instructions maintaining a user account including user security information, user device configuration information, and user content presentation parameters.

14. A computer program product for content subscription, the computer program product embodied on a computer-readable medium, the computer program product comprising:
computer program instructions for receiving from a user device configuration information;
computer program instructions for receiving from a user one or more identifications of content providers for delivery to a device; and
computer program instructions for instructing the one or more content providers to deliver content to the device associated with the device configuration information.

15. The computer program product of claim 14 further comprising computer program instructions for receiving from a user security information.

16. The computer program product of claim 14 wherein computer program instructions for receiving from a user device configuration information further comprises:
computer program instructions for receiving from a user a device ID identifying the target device for content delivery;
computer program instructions for receiving from a user a network address for delivery of the content.

17. The computer program product of claim 14 further comprises:
computer program instructions for receiving from a user content presentation parameters; and
computer program instructions for providing the content presentation parameters to the content subscription service.

18. The computer program product of claim 14 further comprises computer program instructions for maintaining a user account including user security information, user device configuration information, and user content presentation parameters.

19. The computer program product of claim 14 wherein the computer-readable memory further comprises a recording medium.

20. The computer program product of claim 14 wherein the computer-readable memory further comprises a transmission medium.
